(19) United States
(12) Patent Application Publication
(10) Pub. No.: US 2012/0130571 A1
(43) Pub. Date: May 24, 2012

(54) Method for Navigation in No-Passing Zones

(76) Inventor: GREGORY D. DUNKLE, WAYNE, WV (US)

(21) Appl. No.: 13/304,369

(22) Filed: Nov. 24, 2011

Related U.S. Application Data
(60) Provisional application No. 61/417,168, filed on Nov. 24, 2010.

(51) Int. Cl. G05D 1/02

(52) U.S. Cl. 701/21

(57) ABSTRACT

A method for assisting tug boats, work boats and other vessels to navigate no-passing zones, such as narrow channel areas, along an inland and other waterways to avoid passing or overtaking other vessels having the right-of-way according to established waterway rules of the road within the no-passing zones. The method is implemented within an executing computer program, using a database of mile mark distances and of no-passing zones along the length of the waterway.

### CROSS REFERENCE TO RELATED APPLICATIONS

Priority is claimed to the filing date of provisional application, No. 61/417,168, entitled “Navigation in No-Passing Zone,” filed on Nov. 24, 2010.

### BACKGROUND

Rivers, bays, estuaries, inlets and harbors comprise some of the inland waterways used by marine vessels to move various goods into and from the interior of a continent. These inland waterways often have a channel, comprising that part of the lateral width of the inland waterway with sufficient depth to accommodate the draft of marine vessels. The channels often are dredged to maintain sufficient depth for marine vessels. In the United States, dredging and maintaining the navigability of inland waterways is the responsibility of the US Army Corps of Engineers.

A common type of marine vessel operating on inland waterways is a towboat, pushing a number of barges secured together, called a barge tow. The barges can contain various bulk products, such as fuels, petroleum products, chemicals, ores, coal or grain. On the lower Mississippi River south of St. Louis, barge tows may be as large as 40 to 50 barges. Larger towboats, called line boats, are used to push these larger barge tows up and down the river.

Along the Mississippi River are a number of bends in the river. There are also sections of the river in which sediment has accumulated or where a sunken wreck may be found. In these sections of the river, the channel width is constricted or navigation of a large barge tow is difficult, thereby making passing or overtaking another barge tow excessively hazardous of running aground. Therefore, if a vessel skipper feels or determines that a section of the river is insufficiently wide or otherwise too hazardous to safely pass an oncoming, opposing barge tow, he will stop and wait until the oncoming barge tow has cleared the narrow or hazardous area.

On the Mississippi River and its major tributaries, commercial tow boats, line boats and other vessels traveling downstream or with the current have the right-of-way over vessels traveling upstream or against the current. Therefore, if an upstream-bound line boat with a barge tow is approaching a narrow channel area from downstream and learns of another barge tow coming towards him from upstream, the downstream line boats will slow or, if necessary, stop to allow the upstream barge tow to continue to ply downstream until it clears the narrow channel area. Hereinafter, the upstream-bound vessel which must adjust its course and/or speed to accommodate a downstream-bound vessel having the right-of-way is referred to as a “burdened” vessel. The vessel bound downstream having the right of way over a vessel located further downstream and bound upstream is referred to as a “privileged vessel.”

Presently, burdened line boats navigating upstream, when nearing a narrow channel area, will call out on the marine radio to learn of any privileged vessels with barge tows proceeding downstream and approaching the same narrow channel area. The burdened line boat skipper will inquire of the upstream line boat's estimated time of arrival at the narrow channel area. If the privileged vessel is too close to the narrow channel area, the burdened vessel skipper will then adjust his speed accordingly to allow or wait for the privileged vessel to pass through and clear the narrow channel area before proceeding through it himself. Similarly, if the skipper of a privileged vessel learns of a burdened vessel approaching a narrow area from the downstream side, the skipper can call to the burdened vessel by radio and demand it yields the right of way and not enter the narrow area until the privileged vessel passes.

Many line boats, tow boats and other commercial maritime vessels operating on the inland waterways have a radio system called an Automatic Identification System, or AIS. An AIS system automatically transmits on a VHS band a data packet containing a unique ID for the boat, its location, course, and speed along with possibly with other information. A vessel with an AIS system can receive the AIS transmissions from other vessels within the radio range of the AIS transponder. The AIS information from other vessels can then be displayed on a monitor or electronic chart. The skipper of a burdened vessel navigating upstream can then see the information on upstream privileged vessels heading towards his position. If the skipper of the burdened vessel knows the location of narrow channel areas, he can then predict when privileged vessels will enter and exit the narrow channel areas. He can then adjust his speed appropriately, either higher or lower, to avoid passing the privileged vessels within the narrow channel areas.

This method of adjusting a vessel's speed to avoid passing opposing vessels or barge tows is adequate when the downstream vessel captain is very familiar with the channel condition ahead of him, and if there is only one vessel or barge tow heading downstream towards him. If the channel conditions upstream are unknown, if visibility is low or if there are more than one vessel or barge tow heading towards him, then determining the boundaries of narrow channel areas and the times when the area may be clear of downstream-bound traffic becomes too difficult and problematic. This method can be further inaccurate because the skipper must visually judge distances along the river channel. This is often difficult and inaccurate when the river course undulates and meanders across its river plain.

### SUMMARY OF THE INVENTION

In the method described herein, several electronic databases related to the course of a navigable waterway are accessible to a computer. One database contains the result of a survey of the river, in which points, called mile markers, are identified at intervals along the course of the river from a fixed reference point.

Another database contains records of the narrow channel areas along the course of the river, where tow boat skippers generally do not want to pass an opposing barge tow, either as passing in opposite directions or overtaking when travelling in the same direction. These narrow channel areas are hereinafter identified as “no-passing zones.” Each record of a no-passing zone contains the mile marker distance of the upstream and downstream boundaries of the no-passing zone. Each record may contain additional information regarding that no-passing zone, such as any required or practical restrictions on the speed of a vessel navigating through the no-passing zone. This database can be used to visually plot the narrow channel areas of the river on a nautical chart. As used herein, “no-passing zones” may include a system of one or more locks.

In the preferred embodiment, an AIS transponder is provided on the burdened vessel which can receive AIS transmissions from other vessels on the river similarly equipped. The data from the AIS transponder is communicated to a computer, in which a program is executed comparing the received AIS information with the mile marker and no-passing zone databases. The program identifies those vessels upstream of user's vessel travelling downstream, i.e., privileged vessels with respect to this burdened vessel. Then, all no-passing zones between the burdened vessel and the foregoing privileged vessels are identified. For each upstream privileged vessel, its scheduled entering and exiting times at each no-passing zone between it and the burdened vessel is determined. From these schedules, the speed of the user's vessel is adjusted so that the burdened vessel passes through each no-passing zone during time periods when no other privileged vessel will be present in the no-passing zones.

### DESCRIPTION OF THE DRAWINGS

FIG. 1 is an illustration of an inland waterway on which one burdened vessel and several privileged vessels are navigating towards no-passing zones.

FIG. 2 is a plot of the time-vs.-mile mark distance of a burdened and privileged vessel approaching opposite ends of a no-passing zone, illustrating speed changes to the burdened vessel resulting from the present method.

### DETAILED DESCRIPTION OF THE INVENTION

As used herein, “burdened vessel” refers to a vessel navigating upstream and required, under maritime rules of the road, to yield the right-of-way to another vessel.

As used herein, “privileged vessel” refers to a vessel travelling downstream or with the current and having the right-of-way over a vessel located downstream from it. Privileged vessel may also refer to another upstream-bound vessel located further upstream from a burdened vessel and being overtaken by the burdened vessel.

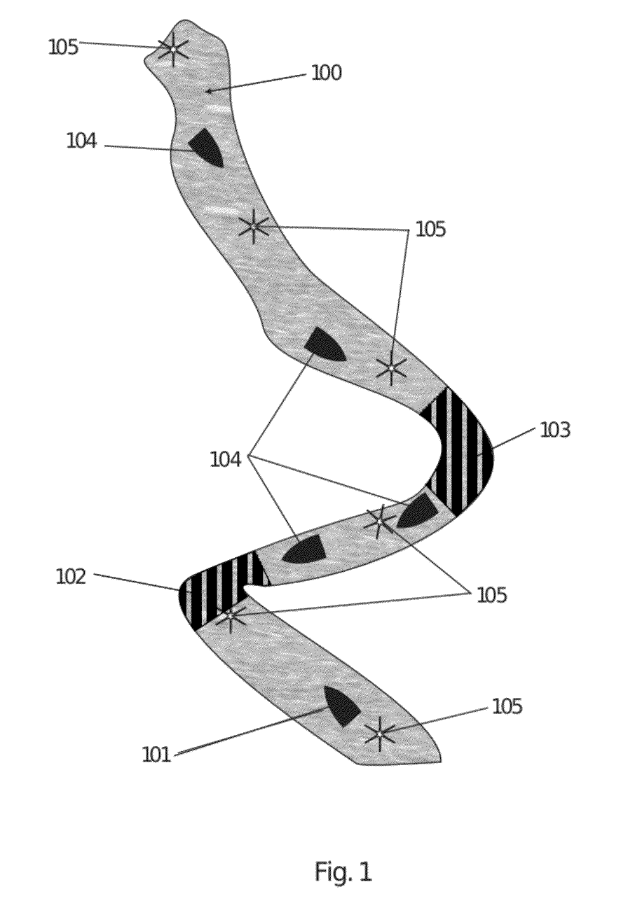

As shown in FIG. 1, a burdened vessel 101 bound upstream is located in the channel of a mainland waterway 101 such as a river. One or more other privileged vessels 104 are located further upstream from the upstream-bound burdened vessel, but proceeding downstream towards the burdened vessel. Between the upstream bound vessel and the one or more downstream bound vessels are one or more restricted no-passing zones 102, 103.

### AIS Transponders

In the preferred embodiment, the burdened vessel and one or more privileged vessels are equipped with AIS transponders. The Automatic Identification System (AIS) is an automated tracking system used on ships and by Vessel Traffic Services (VTS) for identifying and locating vessels by electronically exchanging data with other nearby ships and VTS stations. AIS information supplements marine radar, which continues to be the primary method of collision avoidance for water transport.

Information provided by AIS equipment, such as unique identification, position, course and speed, can be displayed on a display screen or an ECDIS. AIS is intended to assist a vessel's officers and allow maritime authorities to track and monitor vessel movements. AIS integrates a standardized VHF transceiver with a positioning system such as a LORAN-C or GPS receiver, with other electronic navigation sensors, such as a gyrocompass or rate of turn indicator. Ships outside AIS radio range can be tracked with the Long Range Identification and Tracking (LRIT) system with less frequent transmission.

The information in the messages transmitted by an AIS transponder may include one or more of the following:
MMSI: A nine-digit identification number;
The vessel's navigational status, e.g., “at anchor”, “underway with engines;”
The vessel's rate of turn;
The vessel's speed over ground;
The vessel's position, in latitude and longitude;
The vessel's course over ground;
The vessel's true heading; and

The transmission of an AIS transponder is in the form of a stream of text messages. The stream of text messages from another vessel are received by the AIS transponder on the burdened vessel and communicated to a computer. A program running on the computer can then parse the information from text stream and note the time the message was received. It may also display the information contained in it in a more useful graphic format on a display. Such a graphic format could include, for example, displaying an icon on an electronic nautical chart, the icon located in relation to the actual location of the transmitting vessel. The information from the text stream can be displayed in various formats. The identification, bearing, and speed can be displayed in a text box next to the icon; a text box can the pop up when the mouse cursor rolls over the icon; or the text box can pop up when a user clicks with a mouse button on the icon. Alternatively, different shapes, sizes and/or colors may be used for the vessel's icon to represent the vessel's data. For example, a vessel may be indicated by an arrowhead, its direction equivalent to the bearing of the vessel and its size or color indicative of its speed.

If the particular AIS transmitter does not transmit all the data listed above, specifically the course and speed over ground, then the computer into which the data is imported can interpolate that information from a series of positions for the vessel.

An AIS transponder can receive the transmissions of another AIS transponder directly if the two transponders are within VHF radio range. This range is typically about 20 miles, depending on the surrounding terrain. For receiving AIS transmissions from further ranges, retransmission means may be used, such as using a network of radio repeaters, using satellites, using cellular telephony data connections or using various wireless internet connections. Other embodiments of the invention include other radio transponders capable of transmitting data or information on a vessel's location, including cellular phones or GPS receivers.

### Mile Marker Database

Several computer databases related to the course of a navigable river are provided in or communicated to the computer. One database contains the result of a survey of the river, in which points called mile markers 105 are specified along the waterway 100, representing a certain distance along the course of the waterway 100 from a fixed reference point. The fixed reference point is usually the downstream end of the waterway 100, such as the mouth of the river or its confluence with another river. The fixed reference point may also be at the furthest upstream navigable port along the waterway. The identified mile markers 105 in the database are usually at whole integral distance measures from the fixed reference point, using common units of distance, such as miles (either statute or nautical) in the United States or kilometers in Europe and elsewhere. The database also contains the geographic location of each mile marker 105, expressed as latitude and longitude. The database may also contain other information from a survey, such as the width and depth of the channel and the direction of the course of the waterway 100 at the mile marker 105.

In sections of the waterway 100 having turns or tight bends, the database may contain additional mile markers 105 at fractional unit distances between two integral distance mile markers 105. The number and locations of additional mile markers 105 would be provided such that straight lines between two adjacent mile markers 105 would lie substantially within the channel of the waterway.

This database permits any point along the course of the waterway 100 channel to be expressed in terms of its mile marker distance, i.e., its distance from the same fixed reference point used by the mile marker database. If the object's mile marker location must be more precise than that provided by the database, the object's mile marker location can be determined using its geographical coordinates (i.e., latitude and longitude) by interpolating between the geographical coordinates of the adjacent mile markers in the database.

Because a waterway such as a river is dynamic and its course may alter and change over time, especially after floods, the database of mile markers 105 should be periodically updated from new surveys.

The mile marker database may be stored in the computer's memory, including its random access memory, read-only memory, an internal or external hard disk drive, a portable memory stick or USB drive, or other forms of digital data storage well known in the art. In other embodiments, the mile marker database is stored on a remote server in communication with a network, such as the Internet, and its records are retrieved from the remote server by the computer using wireless means to access the network.

### No-Passing Zone Database

The computer program is also provided with a database of records describing the no-passing zones 102, 103 of the waterway. Each record of this database would contain at least the upstream and downstream boundaries 106, 107 of the no-passing zone 102, 103, expressed as mile marker distances. If the mile marker distances of the upstream and downstream boundaries 106, 107 need more precision than the integral distances between mile markers, as contained in the mile marker database, then the locations of the boundaries 106, 107 can be interpolated based on the geographic coordinates of the boundaries 106, 107 and the adjacent mile markers 105. Other information for each no-passing zone record could include the maximum safe speed for proceeding through the region or the present speed reduction necessary to proceed through the region.

The no-passing zone database may be stored in the computer's memory. In other embodiments, the no-passing zone database is stored on a remote server and its records are accessed including wireless means across a network, such as the Internet.

### Locating Objects by the Mile Marker Database

The method for navigating through no-passing zones 102, 103 usually requires knowing the position of mile markers 105 of the relevant burdened and privileged vessels 101, 104 and the boundaries 106, 107 of no-passing zones 102, 103, usually with a precision of 0.1 miles. Since the database of mile markers 105 typically records the distance of each mile marker 105 in integral units of either miles or kilometers, the mile marker distance of an object must be determined by interpolation between two adjacent mile markers 105. To interpolate the mile marker distance of an object a computer program could, for example, calculate the distances from the object to each mile marker using the latitudes and longitudes of the object and the two adjacent mile markers. Using Pythagoras' Theorem, the distance between two points on the earth's surface (for small distances) equals the square root of the sum of the squares of the longitudinal (east-west) distance and the latitudinal (north-south) distance between the two points. For accuracies sufficient for this method, the latitudinal distance is the difference in their latitudes, expressed in decimal degrees, multiplied by 69.172 miles. The longitudinal distance between two points is the difference in their longitudes, expressed in decimal degrees, multiplied by 69.172 miles, multiplied by the cosine of their mean latitude. To interpolate the mile marker distance of the object between the two mile markers 105, the distance between the downstream mile marker 105 and the object is divided by the distance between the two mile markers 105 (which will typically be 1 mile). A more accurate method would be to calculate the dot product of the direction vector from the downstream mile marker 105 to the object with the direction vector from the downstream to the upstream mile marker 105.

### Determining the Next Two No-Passing Zones

In another embodiment of the invention, the method may involve an iteration of the steps concerning the privileged vessels 104 between the next two no-passing zones 102, 103 upriver of the burdened vessel 100. These two no-passing zones 102, 103 will have the next two sets of downriver and upriver boundaries 107, 106 subsequent to the current location of the burdened vessel 100.

### Identifying Privileged Vessels of Interest

Data received by the burdened vessel's 100 radio transponder is routed to a computer able to communicate with the mile marker database and the no-passing zone database for the section of waterway 100 on which the burdened vessel 101 is navigating. From that data, the computer's program determines those vessels which are upstream of the burdened vessel 101 and are travelling downstream towards the burdened vessel 101. These vessels would be privileged 104 and have the right-of-way with respect to the burdened vessel 101.

Because inland waterways 100 often meander, sometimes very significantly, identifying the privileged vessels 104 located upstream on the waterway 100 and travelling downstream is not obvious or readily apparent from that vessel's course. Of the vessels from which AIS or other radio transponder transmissions are received, those vessels upstream of the burdened vessel 101 must first be identified by finding the mile marker distance of each vessel. This may be done by searching the mile marker database and finding the mile marker 105 with the shortest distance from the vessel in opposite directions. The vessel's mile marker distance is then determined by interpolation from the two mile markers 105, as described above. If the mile marker database reference point is the furthest downriver point of the waterway 100, such as its confluence with another river, those vessels with higher mile marker distances than the burdened vessel are upriver of the burdened vessel.

The travel direction of the upstream vessels, with respect to the river, is determined, i.e., whether the upstream vessel is travelling upstream or downstream. This can be done in two steps. First, the course of the waterway where the upstream vessel is located is determined. This course may be contained in the mile marker database for the mile marker nearest the upstream vessel. If the mile marker database does not contain information about the waterway's course, then that course may be determined by determining the vector between the mile marker locations on either side of the upstream vessel. The vector from the higher to the lower mile marker represents the directions of the course of the waterway, if the mile marker reference point is the furthest downstream point of the waterway

Second, the course of the upstream vessel is determined. If the vessel's bearing is in the same direction as vector determined from the nearest upstream mile marker to the nearest downstream mile marker from the vessel, the vessel is travelling downriver, and is a privileged vessel 104, with respect to the burdened vessel 101. If the radio transponder information received from the upstream vessel does not contain its course information, then the upstream vessel's course can be determined by the computer by fitting a vector to the latest series of positions and the times of those positions. The upstream vessels having a course substantially parallel to the waterway's course are making way downstream and are privileged vessles 104 with respect to the burdened vessel 101. It is with these privileged vessels 104 that the method herein avoids passing in no-passing zones 102, 103. These privileged vessels 104 are preferably sorted by their proximity to the burdened vessel 101.

In the next step, those privileged vessels 104 on the opposite side of the no-passing zone 102 nearest the burdened vessel are selected. Preferably these privileged vessels 104 are sorted by their proximity to the burdened vessel 101, as determined by their mile marker distances. Then, the times at which each of these privileged vessels 104 will enter and exit the next no-passing zone 102 upstream of the burdened vessel 101 are determined In the preferred embodiment of this invention, the mile markers reference the distance from the mouth or most downstream end of the subject River.

From the upstream 106 and downstream 107 boundaries of the next no-passing zone 102, the time at which an upstream privileged vessel 104 will enter the next no-passing zone 102 equals the difference in the mile marker distances between the privileged vessel 104 and the upstream boundary divided by the speed of the privileged vessel. The time at which the privileged vessel reaches the downstream boundary 107 the next no-passing zone 102 equals the time to cross the upstream boundary 106 of the next no passing zone 102 plus the distance between the upstream 106 and downstream 107 boundaries divided by the speed of the privileged 104 vessel through the next no-passing zone 102. The speed of the privileged vessel 104 for the no-passing zones 102, 103 generally will equal its prior speed adjusted for any restrictions necessary for proceeding through the no passing zone 102, 103. The periods between when a privileged vessel 104 will enter and exit the next no-passing zone 102 represent a temporal window during which the burdened vessel 101 cannot be within the no-passing zone 102.

If several privileged vessels 104 are heading towards the next no-passing zone 102, then the time periods when each will cross the upstream boundary 106 and downstream boundary 107 of the next no-passing zone 102 are determined. The time periods when no privileged vessel 104 is within the no-passing zone 102 represent when the burdened vessel 101 can traverse the no-passing zone 102.

### Determining the Minimum Speed for the Burdened Vessel

Each privileged vessel approaching the next no-passing zone is examined in turn. First, the minimum speed necessary for the burdened vessel 101 to cross and exit the next no-passing zone 102 is determined. This equals the distance between the upstream boundary 106 of the next no-passing zone 102 and the present position of the burdened vessel 101 divided by the time for the first privileged vessel 104 to reach the upriver boundary 106 of the next no-passing zone 102. If this minimum speed is greater than the maximum cruising speed of the burdened vessel 101, with any barge tow, then the burdened vessel 101 must wait for the first privileged vessel 104 to pass through the next no-passing zone 102. The overall maximum speed to pass this first privileged vessel 104 at or below the downriver boundary 107 of the next no-passing zone is determined. The speed of the burdened vessel can be set at or below this overall maximum speed, depending on the preferences of the burdened vessel's skipper. Based on this chosen speed, the position of the burdened vessel when the first privileged vessel exits the next no-passing zone 102 can be determined.

This step is repeated with the second privileged vessel 104, aft of the first privileged vessel 104, using the burdened vessel's 101 new position at the time when first privileged vessel 104 passes the downriver boundary 107 of the next no-passing zone 102. It may be necessary for a burdened vessel 102 to wait for the second privileged vessel 104 to clear the no-passing zone 102, as well, depending on the distance of the second privileged vessel 104 behind the first, and on the length of the no-passing zone 102.

When the minimum speed to successfully traverse the first no-passing zone 102 found for the nth vessel is within the capability of the burdened vessel, the speed of the burdened vessel 101 is set at least to this minimum speed. The burdened vessel 101 will clear the no-passing zone 102 and pass its upriver boundary 106 before the nth privileged vessel 104 reaches the upriver boundary 106 of the next no-passing zone 102.

In other embodiments of the invention, the above steps may be repeated for the subsequent no-passing zones 103 once the minimum speed for the next no-passing zone 102 has been determined. The identity and order of privileged vessels 104 upriver of the subsequent no-passing zone 103 are found and their times of arrival and departure through the subsequent no-passing zone 103 are found. From these, the minimum speed to reach and pass through the subsequent no passing zone 103 is set. If the minimum speed is greater than the burden vessel's current speed navigating through the next no-passing zone 102, it can increase its speed to assure reaching and traversing the subsequent no-passing zone103 . Determining the necessary minimum speed for crossing the subsequent no-passing zone while still at or near the next no-passing zone assures the minimum speed for each no-passing zone, while reducing the times a burdened vessel must unnecessarily stop at the downriver boundary of any no-passing zone.

These steps are repeated as the burdened vessel 101 proceeds upriver. As the method reaches a solution for traversing the next no-passing zone 102 without passing a privileged vessel, it begins solving for passage through the subsequent no-passing zone 103 . If the solution for the subsequent no-passing zone 103 is within the solution of the next no-passing zone 102, the speed of the burdened vessel 101 is adjusted accordingly to satisfy both solutions to travel at the most efficient speed without unnecessary stops and delays. As the burdened vessel 101 passes through the next no-passing zone102, the subsequent no-passing zone 103 becomes the next no-passing zone 102 in the above methodology, and the no-passing zone further beyond becomes subsequent no-passing zone 103, as those terms are used in the methodology above.

On occasions, an upriver-bound vessel trailing behind another, slower moving upriver-bound vessel or barge tow desires to overtake that vessel ahead (not shown in FIG. 1). In this situation, the vessel overtaking the other is the burdened vessel, and the vessel being overtaken is the privileged vessel with the right of way. In such a situation, the burdened vessel desires to complete the overtaking maneuver while there are no downriver vessels passing them and outside of a no-passing zone.

To determine the minimum speed necessary to complete an overtaking maneuver, the necessary distance to overtake the privileged vessel is calculated, based on the geographical positions of the two vessels and the necessary distance must be ahead of the privileged vessel to complete the overtaking maneuver. First, the distance between the privileged vessel and the next no-passing zone is determined. The time available equals that distance divided by the speed of the privileged vessel. The minimum speed equals the distance of the burdened vessel to the no-passing zone divided by the available time. If that minimum speed is greater than the capability of the burdened vessel, the burdened vessel must wait to overtake until passing through the no-passing zone.

After determining the minimum speed with respect to the privileged vessel, any possible meeting with a downriver-bound vessel must be determined, from their AIS transmissions. Using the current location and speed of any downriver-bound vessel, its position at the end of the overtaking maneuver is projected. If this position is at or beyond that of the burdened vessel, then the overtaking maneuver cannot be completed at the aforementioned minimum speed.

A new minimum speed may be calculated to both overtake the burdened vessel before passing any approaching downstream-bound vessel. First, the position and time at which the burdened vessel and approaching vessel meet is calculated. If this point is beyond where the privileged vessel will pass the burdened vessel, and the time to meet the approaching vessel is greater than the time necessary to overtake the privileged vessel, then the burdened vessel may proceed to overtake the burdened vessel.

If, however, the approaching vessel will meet the burdened vessel prior to overtaking the privileged vessel, then a new, higher speed may be calculated. To overtake the privileged vessel before passing the approaching vessel, the burdened vessel must reach the position that the approaching vessel passes the bow of the privileged vessel & barge tow, plus a margin of safety, before the approaching vessel reaches it. This point will be reached in a time period equal to the net closing speed of the approaching and burdened vessels, divided by the current distance between the two vessels minus any distance allowed for their barge tows and for a safety margin. If this time period is longer than the prior time period for overtaking the privileged vessel at the minimum necessary speed, then the approaching vessel will have no effect on overtaking the privileged vessel.

The location of this new overtaking point equals the speed of the burdened vessel multiplied by the new time period, plus the length of the privileged vessel's barge tow and any safety margin. The new minimum speed for the burdened vessel equals the distance between the burdened vessel and the new overtaking point, divided by the new time period. If this new minimum speed is greater than the capabilities of the burdened vessel, then the burdened vessel must wait until the approaching vessel passes, and the process is repeated. If not greater than the vessel's capability, the speed of the burdened vessel is adjusted to at least the new minimum speed and the overtaking maneuver is carried out.

The various geographic points at which the burdened vessel will overtake another upriver bound vessel or will pass a downriver bound vessel can be displayed on the electronic navigational chart.

### EXAMPLE

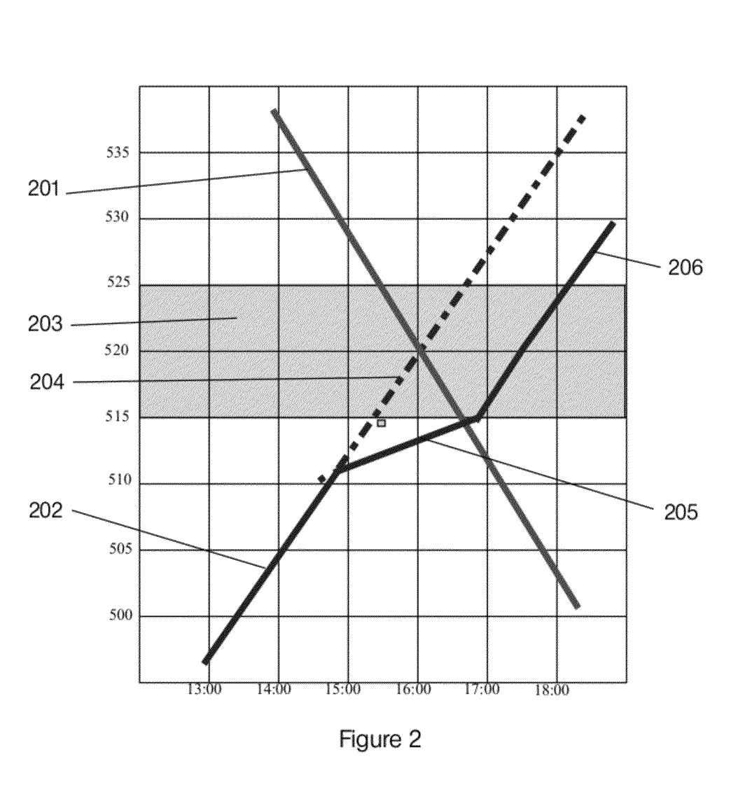

An example of the method in practice is illustrated in FIG. 2. In the graph of FIG. 2, the horizontal axis represents clock time, and intervals are labeled according to military or GMT time. The vertical axis represents distance along a waterway, with intervals shown in mile marker distance. The track of a burdened vessel proceeding upstream is shown as 202, while the track of a privileged vessel proceeding downstream is shown as 201. Just prior to 15:00 hours, the AIS transponder of the privileged vessel comes within range of that of the burdened vessel. The computer programmed to implement this method receives the text messages from the transponder of the privileged vessel, and determines it will enter the next no-passing zone 203 at about 15:30 and exit it about 16:45. The projected path 207 of the burdened vessel will enter the no-passing zone at about 15:20 and exit at about 16:40, crossing the privileged vessel at about 16:00, in the middle of the no-passing zone.

Accordingly, the computer running the program which implements the present method calculates the maximum speed for the burdened vessel to enter the no-passing zone at or after the privileged vessel enters the no-passing zone. This maximum speed track 205 crosses the track of the privileged vessel immediately after it exits the no-passing zone.

I claim:

1. A method for assisting navigation of a vessel in a no-passing zone, comprising:
A. Providing a first vessel with a radio transponder, wherein the radio transponder can transmit and receive messages containing at least information about another vessel's location;
B. Providing the first vessel with a computer, wherein the computer is programmed to be capable of:
i. Accessing a database of mile-mark distances for the waterway on which the first vessel is navigating;
ii. Accessing a database of one or more no-passing zones for the waterway on which the first vessel is navigating;
C. Receiving radio transponder information from at least one other vessel operating on the same waterway;
D. Using a program executing in the computer:
i. determining the mile-mark distance of the first vessel on the waterway, using the database of mile marker distances;
ii. determining the mile-mark distance, speed and direction of the at least one other vessel, using the radio transponder messages received from the at least one other vessel;
iii. determining the sequence of no-passing zones located ahead of the first vessel, using the database of no-passing zones;
iv. determining the times at which the first vessel enters and exits one or more no-passing zones ahead of it and whether the at least one other vessel will be within the at least one no-passing zone simultaneously; and
v. determining a necessary change in the first vessel's speed to avoid being within the at least one no-passing zone simultaneously with any one or more other vessels.

2. The method of claim 1, wherein the first vessel's speed is adjusted by the necessary change in speed determined to avoid being within the at least one no-passing zone.

3. The method of claim 1, wherein the radio transponder messages received from at least one other vessel include the at least one other vessel's speed and direction.

4. The method of claim 1, wherein the AIS transponder message received from the at least one other vessel does not include the at least one other vessel's speed and direction, and further comprising the step of, using the program in the computer, determining the at least one other vessel's speed and direction.

5. The method of claim 1, wherein the at least one no-passing zone comprises a bend in the waterway.

6. The method of claim 1, wherein the at least one no-passing zone comprises a lock or system of locks.

7. The method of claim 1, wherein the other vessel is moving along the waterway in the opposite direction from the first vessel.

8. The method of claim 1, wherein the other vessel is moving along the waterway in the same direction as the first vessel.

9. The method of claim 1, wherein the database of mile mark distances comprises distances along a waterway from an identified geographical location.

10. The method of claim 9, wherein the database of mile mark distances contains the latitude and longitude coordinates of each mile mark distance.

11. The method of claim 1, wherein the no-passing zone datebase contains the mile mark distances of either end of the no-passing zones.

12. The method of claim 1, wherein the first vessel is a vessel selected from the group consisting of a towboat, or work boat and a barge.

13. The method of claim 1, wherein the at least one other vessel is selected from the group consisting of a towboat, a workboat and a barge.

14. The method of claim 1, wherein the database of mile mark distances is stored on an accessible storage medium selected from the group consisting of the computer's memory and a remote server.

15. The method of claim 1, wherein the database of no-passing zones is stored on an accessible storage medium selected from the group consisting of the computer's memory and a remote server.

16. The method of claim 1, wherein the substeps in Step D are repeated for subsequent no-passing zones.

17. The method of claim 16, wherein one or more necessary amounts of changes in the first vessel's speed to avoid being within each of the subsequent no-passing zones simultaneously with any one or more other vessels is determined.

18. The method of claim 17, wherein the speed of the first vessel is changed by the one or more amounts determined to be necessary to avoid being within each of the subsequent no-passing zones simultaneously with any one or more other vessels.
